(19) United States
(12) Patent Application Publication
(10) Pub. No.: US 2025/0217901 A1
(43) Pub. Date: Jul. 3, 2025

(54) SYSTEMS AND METHODS FOR RECONCILIATION IN MINE PLANNING

(71) Applicant: FREEPORT MINERALS CORPORATION, Phoenix, AZ (US)

(72) Inventors: Brian Njenga, Phoenix, AZ (US); William J.A. Stavast, Jr., Tucson, AZ (US); Michael Tharby, Vail, AZ (US); Logan Hill, Morenci, AZ (US)

(73) Assignee: FREEPORT MINERALS CORPORATION, Phoenix, AZ (US)

(21) Appl. No.: 18/400,920

(22) Filed: Dec. 29, 2023

(51) Int. Cl. G06Q 50/02; G06Q 10/047; G06Q 10/0631; G06Q 10/0637

(52) U.S. Cl. CPC G06Q 50/02; G06Q 10/047; G06Q 10/06315; G06Q 10/0637

(57) ABSTRACT

The system comprises an automated data platform for reconciliation. The system may use geologic data and mine data to digitize and automate reconciliation, to determine the impact of various models, to assist in real time decision making for adjusting mine operations and/or to improve mining production. The method comprises associating shovel load locations with a forecast model block and a district model block; selecting a plurality of shovel loads that are associated with the forecast model block and the district model block, based on the shovel load locations; matching the plurality of shovel loads with the truck load; aggregating the plurality of shovel loads into the truck load; comparing forecast model block characteristics of the forecast model block and district model block characteristics of the district model block with target block characteristics of a target block; and creating a reconciliation report of the target block characteristics of the target block based on the forecast model block characteristics and the district model block characteristics.

### FIELD

This disclosure generally relates to an automated data platform for mine planning reconciliation, and more particularly, to using geologic data and mine data to digitize and automate reconciliation, to determine the impact of various models, to assist in real time decision making for adjusting mine operations and/or to improve mining production.

### BACKGROUND

Geological or mining reconciliation is the process that site geologists use to determine if the yield from the mining process meets the expected or forecasted yield. In that regard, reconciliation often provides an indication of the accuracy of the predictions of the long-range models. By using the long-range models, reconciliation may be a basis for mine planning, ore control, production rates and production amounts.

The reconciliation process is important because regulatory agencies may require reporting of the mineral resources and mineral reserves associated with mine planning and financials. Moreover, the standards for the accuracy of the long-range models may be audited regularly (e.g., as part of controls and audits under the Sarbanes-Oxley Act of 2002 that mandates certain practices in financial record keeping and reporting for corporations), so conducting an accurate and timely reconciliation process is valuable. In that regard, the standard is for the long-range models to be within 10% of the short-range models for grade, tonnage and contained copper pounds on an annual basis (e.g., a rolling 12-month period).

However, reconciliation may have challenges in that the reconciliation process is often completed manually and written on physical papers. The reconciliation process also often involves a large amount of generated data. Some of the data sets currently used in the reconciliation process may be, for example district model block data, forecast model block data, target block model data, blasthole data, dispatch data, reference tables, cutoff tables, ore type data, route data, pit data, rock type data, etc. The reconciliation process may take weeks to capture, organize and understand such data. In fact, the manual process may require numerous employees manually entering data for over 2 hours a day. As such, the reconciliation process is often a very time-consuming process with the possibility for human-centric calculation errors. The reconciliation process may also include multiple excel files and the periodic re-working of the process to correct mistakes. Moreover, the results are typically not digitized and are not included in a user-friendly dashboard.

As part of the manual process, an engineer may manually backfill missing data (e.g., grades) about the mined material on a daily basis. The grades may include a copper grade, acid soluble grade, molybdenum grade, QLT grade, rock type, ore type, minerology data, etc. Moreover, in existing systems, the reconciliation process may only include one economic cutoff file and one recovery file for a month. However, such data may change depending on the ore type or rock type, may change throughout the month and may change in different blocks. As such, it would be advantageous for the reconciliation process to be digitized and automated to help with determining the impact of various models, to assist in real time decision making for adjusting mine operations and/or to improve mining production.

### SUMMARY

The system may perform a method comprising finding shovel load (e.g., dipper) locations between a period of time based on shovel load data from truck load data from a truck load of material; associating the shovel load locations with a forecast model block and a district model block; selecting a plurality of shovel loads that are associated with the forecast model block and the district model block, based on the shovel load locations; matching the plurality of shovel loads with the truck load; aggregating the plurality of shovel loads into the truck load, based on the truck load data, shovel load characteristics of the plurality of shovel loads being associated with forecast model block characteristics of the forecast model block and district model block characteristics of the district model block; comparing forecast model block characteristics of the forecast model block and district model block characteristics of the district model block with target block characteristics of a target block; and creating a reconciliation report of the target block characteristics of the target block based on the forecast model block characteristics and the district model block characteristics.

The forecast model block may be part of a forecast model block. The district model block may be part of a district model block. The selecting the plurality of shovel loads that are associated with the forecast model block and the district model block may comprise obtaining a value of a forecast model block for each of the plurality of shovel loads; and obtaining a value of a district model block for each of the plurality of shovel loads. The method may further comprise obtaining centroid data about the forecast model block and the district model block from the shovel load data for the truck load; matching the centroid data to centroid data of the target block; and determining the target block.

The method may further comprise assigning a route code (e.g., optimal processing destination) to the truck load based on the truck load data. The method may further comprise re-calculating a route code based on grades in the forecast model. The method may further comprise calculating a cut-off and a route code using the economic cutoff grades. The truck load data may include at least one of ore type, rock type or grade. The method may further comprise determining copper recovery from the target block by the comparing of the forecast model block characteristics of the forecast model block and the district model block characteristics of the district model block with the target block characteristics of the target block. The reconciliation report may include the differences from the target block characteristics of the target block with the district model block characteristics.

The method may further comprise determining at least one of the shovel load data that is missing or the shovel load data that does not match the truck load data. The method may further comprise backfilling the shovel load data that is missing by using at least one of shovel cut data, spatial data, prediction data, average data from past truck loads, or last known data from the past truck loads. The method may further comprise backfilling the shovel load data that is missing by using shovel cut data from shovel cut files from the period of time and over the shovel load locations.

The method may further comprise overlaying a shovel cut progress polygon over a block model of a mine having a plurality of blocks; determining a first subsect of the plurality of blocks that are fully contained within the shovel cut progress polygon, wherein the first subset of the plurality of blocks have first characteristics; determining a second subset of the plurality of blocks that are partially contained within the shovel cut progress polygon, based on one or more vertices or centroids being within the shovel cut progress polygon, wherein the second subset of the plurality of blocks have second characteristics; and backfilling the shovel load data that is missing with shovel cut data having the first characteristics and a percentage of the second characteristics. The method may further comprise determining a percent of a block that was mined. The method may further comprise determining a target block corresponding to the shovel load locations; and determining the percentage of the target block that was mined.

The method may further comprise forecasting, using a mine plan with user-defined table functions (UDTFs), areas of polygons to be mined first over a period of time. The method may further comprise displaying mined areas overlayed on a mine plan, wherein the mine plan includes areas that should have been mined. The method may further comprise creating area categories in a mine plan as at least one of mined as planned, planned not mined, mined not planned or routed outside of the mined plan. The method may further comprise determining, based on tons and grades inside each of the area categories, at least one of percentage of time mining operations achieved the mine plan as forecasted, percentage of the material that was moved forward from subsequent months, percentage of the material that was deferred or how each of the area categories impacted the amount of metal that was obtained. The method may further comprise determining, using recovery data, that a mine plan recovered an amount of metal that was planned. The method may further comprise joining the truck load data into the shovel load data using a load shift index, load number and shift date.

The method may further comprise joining the shovel load data into mapping tables using pit name, mined pit code and centroid z. The method may further comprise providing, using mapping tables, consistent data for models. The method may further comprise displaying a point representing a shovel scoop of the material and at least one of projected yield of the material, routes for the material or processing locations for the material. The method may further comprise determining, using a cutoff file, a threshold grade for a type of the material for routing the material to a processing facility and/or area (e.g., that may be most appropriate for the type and grade of material).

### BRIEF DESCRIPTION OF DRAWINGS

A more complete understanding of the present disclosure may be derived by referring to the detailed description and claims when considered in connection with the Figures, wherein like reference numbers refer to similar elements throughout the Figures, and:

FIGS. 1A-1C include an exemplary chart that shows the use truck load data and all shovel loads (e.g., dippers) associated with that truckload, in accordance with various embodiments.

FIG. 2 is a graphical representation showing a method for determining the percentage of the block characteristics that should be included in the polygon data, depending on the parts of the block that are within the polygon, in accordance with various embodiments.

FIG. 3 is a graphical representation of the inputs and outputs from the system, in accordance with various embodiments.

FIG. 4 is a graphical representation of the relationships of the MMT tool and blocks, in accordance with various embodiments.

FIG. 5 is an exemplary user interface showing a zone in the mine with recovery data for the different block models, in accordance with various embodiments.

### DETAILED DESCRIPTION

In general, the system includes an automated data platform for reconciliation. The system uses data from the mine material tracking (MMT) tool to automate the reconciliation process. The system may include a mining optimization form of analytics and a material management protocol for mining that may be involved in the life cycle of the exploration model. Automation of the reconciliation process may enable geologists and mine engineers to learn from reconciliation data and suggest real-time operational adjustments. The system may broaden the understanding of business drivers and may enable informed decision making throughout the entire mining lifecycle. The system and data may also allow a deeper dive into the root cause analysis for yield variances.

The system may use inputs such as, for example, a long-range model (e.g., district model block), a forecast model block, cut-off tables, shovel cut files, mapping tables, a short-range model (e.g., blast hole data) and recovery factors. Recovery factors are used to determine if the mining operations were able to recover the amount of metal that was planned. The system may combine the data into a data warehouse using ETL (extract, transform, load). The system may use a platform (e.g., Redwood) to move at least a portion of the data into the cloud and/or into the system. The system may store the block models for future use and may compare current block models to previous block models.

In various embodiments, the system may also save time for the engineers in ore control. Ore control is among the many mining processes, with the objective of correctly categorizing materials by means of classification polygons. Each class of material may be sent to the appropriate destination that generates the greatest economic benefit for the operation. Ore control may be part of many of the actual production models because ore control may impact the assigning of the routing of the material. Ore control may also be involved with the assigning of the grades of the mined material. The ore control may be used with the geological data to reconcile differences between the geologic models and actual production models.

The reconciliation system may compare long-range models to short-range models. The system provides detailed data to help improve long-range models. The long-range model may be referred to as, for example, district model, exploration model, resource model, drill hole model or geologic model. The long-range model may predict copper, molybdenum, other precious metals and other metal grades. A company may base its resources and reserves on the long-range models. Long-range models may be used to determine a life of mine plan, which could include a 20-plus year time frame. The long-range models may be calculated from exploration drill (core) holes (e.g., drill holes placed 250 feet apart). The long-range models may update periodically (e.g., once per year). The system may use the current version of the long-range model, until the update is implemented.

A short-range model may be referred to as, for example, a blast hole model or target block model. The short-range model may be used to determine what material is to be mined in a short time frame (e.g., the next day, next week or next month). The short-range models use blast hole data (e.g., blast holes placed 20 feet apart), so the short-range models provide more resolution (more detailed data). The short-range models may update periodically (e.g., daily).

A production model is a similar model as a short-range model, but the production model is used to model the actual movement of the material (as opposed to where the material was predicted to be moved). The actual movement of the material may change daily based on various factors (e.g., equipment availability, operational constraints, etc.). A forecast model may combine long-range data and short-range data to help forecast out the next period (e.g., 5 years). The forecast model may use any combination of the long-range data and short-range data. The forecast model may use weighting factors for certain of the long-range data and short-range data. In various embodiments, the forecast model may prioritize and use the short-range model when available.

The system may utilize the block models that include multiple blocks over an area on a first level, and additional blocks for each level of the mine. Each block has a centroid with an x-y-z axis. The block sizes are based on the exploration data because the data density from the exploration holes may be limited, so the block size is larger. Blast holes may provide higher density data, so the system may use smaller blocks. However, the system may still divide up the larger blocks into smaller blocks (e.g., 20 ft×20 ft) because the drilling may be on the order of every 20 feet. However, greater or lesser distances may be used. The system preferably does not use blocks that are less than the selective mining unit of the equipment. The shovel may be part of the large excavators that are used in the open pit to move blasted Run Of Mine (ROM) material onto haul trucks/conveyers. Shovel cut may include the “cut” in the ore pile after a scoop of ore is removed. In other words, the shovel operator lowers the shovel bucket into a rock face or ore pile, raises the bucket through the material, and then retracts it. The shovel then rotates the bucket away from the “cut”, dropping the material into a truck/conveyor. In various embodiments, a shovel load may include a dipper or any other tool, equipment, machine, compartment or container that may mine, extract, scoop, carry, transport and/or obtain material. A dipper may include the bucket of the shovel that lowers into and scoops up the material.

The system may compare each block in a first model of a site to each block in a second model and determine the differences in each block. The system may use a single query for this comparison, instead of running a script for each model to be compared.

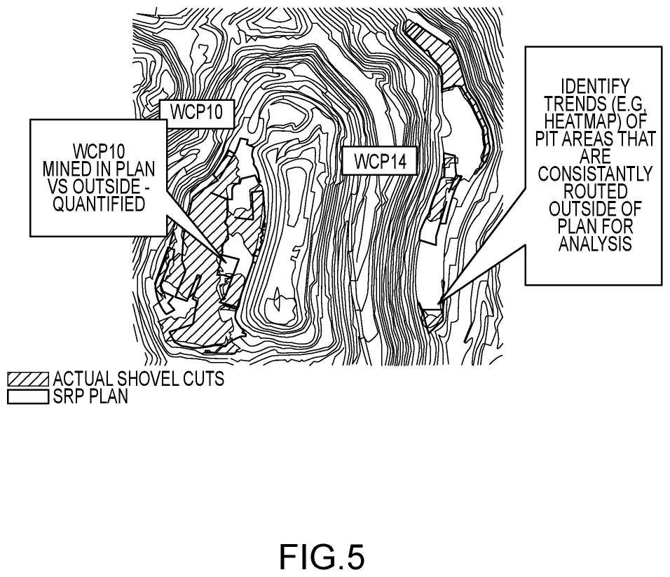

With respect to model comparisons, the system may filter areas by comparing models across areas of interest. As set forth in FIG. 5, in various embodiments, the system may upload an area of interest. Similar to shovel cut patterns, the system may allow the user to analyze rock type in a particular zone in the mine (or over various mines) to determine if the zone provided accurate recovery data for the different block models over a certain number of years. The system can provide the rock type domain, boundary and recoveries to the models to determine a new rock type to mine in that area. As such, the polygon data may limit the reconciliation to a spatial domain. The system may report any reconciliation across any model in the data warehouse based on data within that boundary.

The system may also develop curves (e.g., cut-off grades (x) v. tonnage (y)) for any model in the data warehouse. The system uses the curves to determine how much tonnage of copper (of the total tonnage in the mine) may exist in an area that is above a certain cut-off grade. A larger tonnage will exist above a lower cut-off grade (0.01% copper), but a smaller tonnage will exist that is above a higher cut-off grade (0.1% copper). If a big step-change profile of the curve exists between models for the area, then the system may determine that a problem may exist.

The system may also provide certification of the models in the data warehouse, prior to running the models to predict data for reserve plans, life of mine plans, etc. The system may run production data over a period of time (e.g., 36 months) in the model to determine if the model provides accurate results. The system may also automate the model certification by utilizing the existing cutoff mapping to calculate the routing. When conducting the certification process with the production data, the system does not impact the production data. The system may receive a small change to the data, then the system can re-run the models to determine if the reconciliation is better or worse from that change. Instead of relying on one set of data from the same area, the system may also use the areas of the mine that provide the most accurate data to create the models.

The block model provides an understanding of ore placements into the stockpile. In various embodiments, the block model may use drill hole data to map the location of the ore (e.g., in 3 dimensions), metal contents, geologic data and/or mineralogy. The drill hole data may be used determine blast size, blast pattern and a blast plan used to determine the drilling and blasting design. The blast does not excessively disrupt the ore, so the location of certain mineralogic areas is still known (e.g., high grade ore area, low grade ore area, high clay area, etc.). The locations of those mineralogic areas may be associated with different shovel loads, truck loads, etc. For example, the system may have data about a specific truck on a specific day obtaining ore from a particular location, and that ore has certain mineralogic features. Based partly on the haul truck sensors and the dispatch system, the system may have data about where the ore was obtained, where the ore is placed in the stockpile, when the ore was placed on the stockpile, the order that the ore was placed on the stockpile and other data about the ore. As such, the system includes a full block model of the final placement tracking system.

The geologic block model may obtain information from drilling, assaying, geotechnical work, mapping, etc. to help determine conditions. Geo-statistics and tools may interpolate and extend values into all pertinent blocks. The block model may include a spatially correct database of the geology information based on sampling and geologic interpretation. Each block may maintain many items that are coded with quality (e.g., metal grades, type of materials, lithology, alteration, etc.) and quantity (e.g., densities, topographic completeness, structures, etc.) codes and information. The block model may visually display the block model grades and HPGPS (high-precision global positioning system) dig points. As such, the block model may include adding value in block models based on analytics output.

The block model may provide coordinates for the ore. The ore may be drilled and blasted, then the system is made aware of material displacement in the block model based on how the ore may have been moved in the blast. The system may provide the data about the new location of the ore and the contents of the ore to the shovel which will load the ore into large haul trucks for transport to appropriate destinations. The system may also include the capturing of dig coordinates with each scoop of the shovel bucket, so the shovel or system can determine if a certain ore section is in that particular scoop. The system may use CAES (computer aided earthmoving system) products called Terrain or ProVision to obtain the scoop data. The system or shovel may determine where the ore should be placed based on the contents of the ore in the scoop, after the ore is scooped up by the shovel. For example, the system may determine that a first ore scoop with more copper content should be placed in a first truck that is scheduled to go to a particular leach stockpile, while a second ore scoop with less copper should be placed in a second truck that may be scheduled to go to a mill or different area.

In various embodiments, the system may reference validated data against automated calculations. The system may determine the percent of a block that was mined based on the automated reconciliation calculations. The system may use truck load data to find dipper locations between a period of time (e.g., between two dates). The system may also use the dipper data to determine the target block that the dipper was digging in. The system may additionally use the dipper data to determine the percentage of the block that was mined by the dipper. The outcome of these determinations may be used to validate the routing calculations.

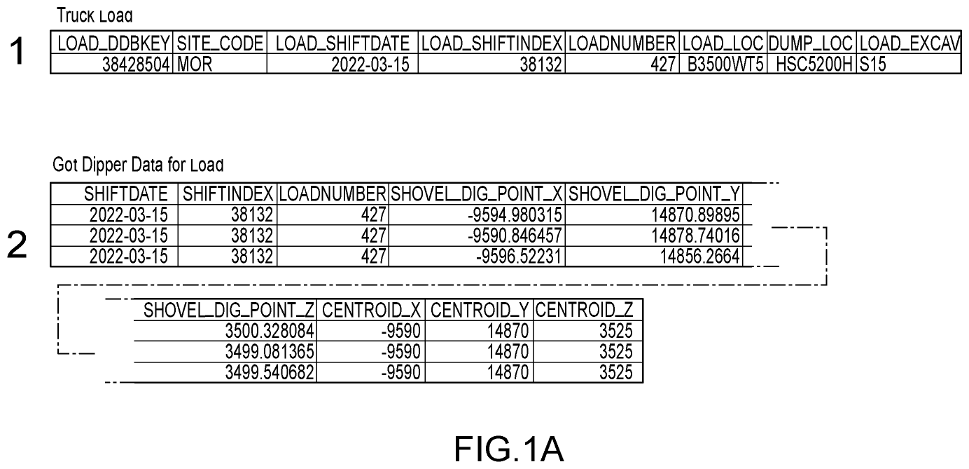

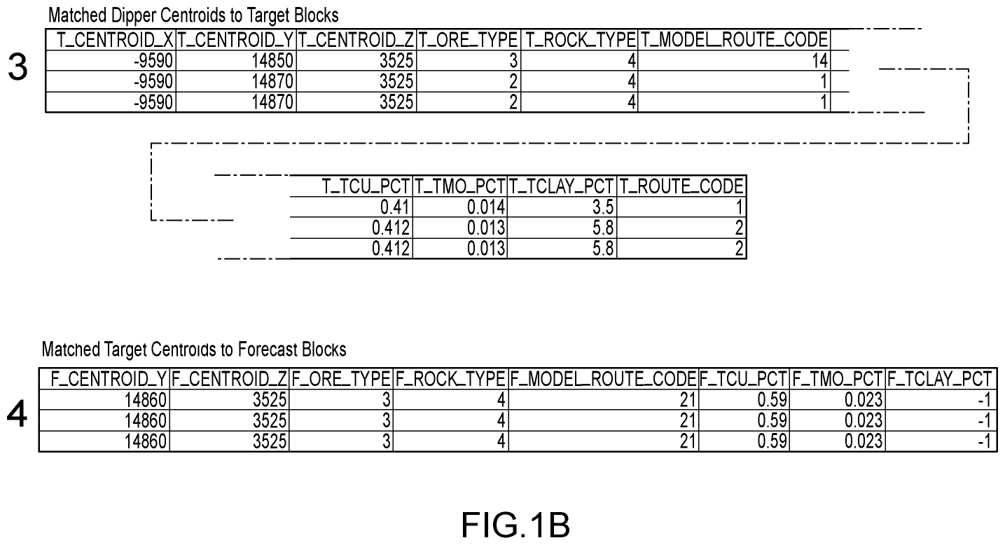

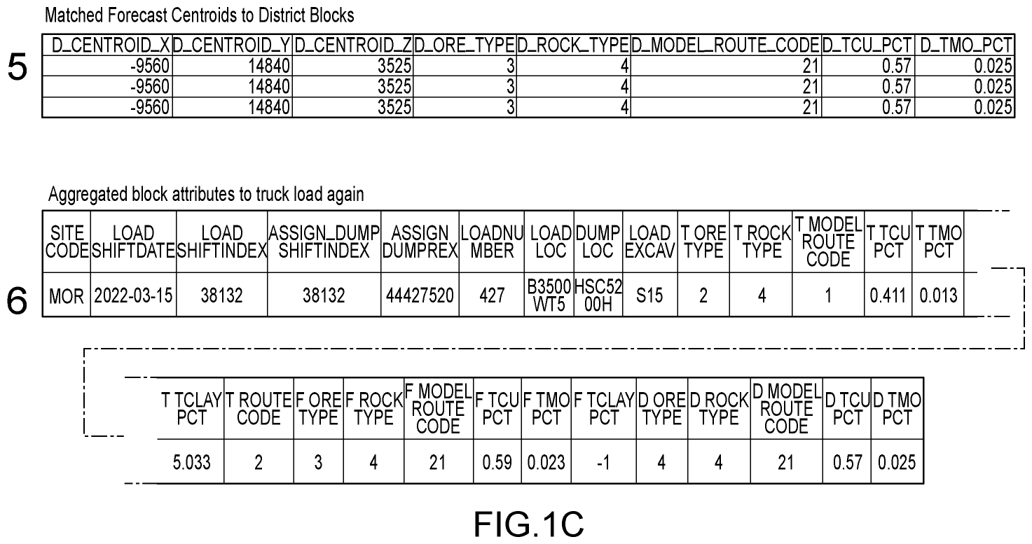

In various embodiments, the system may automate the process for obtaining the data about what blocks were actually mined. In various embodiments, and as set forth in FIGS. 1A-1C, the system may use truck load data and find a plurality of dippers associated with that truckload. The system may obtain the dipper data between a period of time (e.g., between two dates). Each of the dippers may be in a block, and the block may be in a block model. Each of the blocks may be different sizes, and each type of block model (e.g., short-range block model, long-range block model and forecast model) associates a different number with each block. As such, the system may obtain centroid data (about the block) from the dipper data for the truck load. The system matches the centroid data to target blocks. The system then uses the short-range model data for the target blocks. The system matches the target block centroids to the forecast model blocks and long-range model, which may include different sizes of blocks.

The system may associate the dipper locations with forecast model block and the district model block. The system may use the dipper location data to determine the dippers that relate to the forecast model block data and the district model block data. More particularly, the system obtains the value of the forecast models for each of the dippers. The dippers may have the same ore type, rock type and grades because the dippers are in the same forecast model block. The system obtains the value of the long-range (district) models for each of the dippers. If the dippers are in the same long-range block, then it may be presumed that the dippers may have the same ore type, rock type and/or grades.

The system may match the dippers in the same block with the truck load data and aggregate those dippers in the same blocks into the truck loads. In particular, the system aggregates the model attributes (e.g., from the short-range block model, long-range block model and forecast model) back to the truck load. The system may re-calculate all codes (e.g., route codes) based on the grades in the forecast or long-range model. Based on the ore type, rock type and grade, the system may assign a route code to the truck load. The route code may represent the optimal processing destination and may indicate where the material went for processing (leaching, mill, etc). The system may also calculate the route codes based on the economic cut-off metal grades. The system may then determine copper recovery by comparing tons, extracted copper, etc from the long-range (district) block model and the forecast model block with the short-range (target) block. As such, the system may provide complete end-to-end geology reconciliation, without the need to manually backfill grades. The reconciliation reports the differences in the data between the long-range model and the short-range model.

The system may also provide comprehensive, detailed and real-time dashboards that may be filtered by any time period. In various embodiments, the dashboard may include the curated data shape that includes the short-range block model, long-range block model and forecast model. For example, the dashboard may include tons of metal based on rock type and routes. The dashboard may include a comparison of grade against tonnage using truck loads. In particular, the dashboard may include a graph that represents the tonnage by TCU grade curve for both short-term block model (STP) and long-term block model (LTP). The STP block may be known as a target model. The LTP block may be known as a district model. The dashboard may also include tonnage distribution by STP route and LTP route. The route processes may include, for example, crush leach, mill, ROM and waste. A table may show the different combinations of route processes and the percent tonnage distribution. The LTP route may be on the x-axis and the STP route may be on the y-axis, so the graph may represent the distribution of STP tons versus LTP tons by route. The dashboard may include the tonnage by block model route using truck load data. In particular, the dashboard may include a graph that represents the amount of total tonnage being routed to different routes in both STP blocks and LTP blocks. The bar graphs may include the y-axis with dump tons metric and the x-axis with either STP route processes or LTP route processes. The dashboard may also include spatial analysis of a route by block, dippers and shovel cuts. The dashboard may include filters related to bench, source, month and/or route. The dashboard may provide filtering based on month, source, bench, route and/or common block flags.

The dashboard may also include data validation graphs using any timeframe. For example, the graphs may include number of blocks by model date with block count compared to the effective start time stamp (STRT TS). The graph may include the number of modify dates for shovel cuts with a system record to determine if a record in the database has changed (e.g., DISTINCT_MODIFY_TS) against shovel cut date. The dashboard may further include data about shovel cuts in a time period based on number of rows by shovel cuts. The graph may include DISTINCT_MODIFY_TS against the effective start date (EFF_STRT_TS). The effective start date may be used for associating certain input files with the corresponding date range. The dashboard may further include data about cutoff files based on number of rows by cutoff date and pit phase. The graph may include a block count (BLOCK_COUNT) against EFF_STRT_TS. The dashboard may further include data about shovel cuts based on number of rows by shovel cuts. The graph may include BLOCK_COUNT against EFF_STRT_TS.

The mine material tracking (MMT) tool is essentially a GPS on a shovel that collects data including geographic location data of the material. The data may include x-y-z data about material that a shovel collected. However, if the system (e.g., mesh network) is not operating correctly, the GPS data may not be obtained. During those times when the MMT data is not available, the engineers may need to backfill data about where the engineer knew the shovel was digging during that time period. The engineers may use data from the short-range model to determine the areas that were mined during a time period. The system may find the file names that include data ranges within the desired date range, so the appropriate files with the missing data can be reviewed. The engineers may then determine the data (or grades) that are missing in the MMT data in those areas, then backfill the missing data into the system.

As an example, for a certain period of time (e.g., 6 months), the system may obtain 77% of the truck load data. MMT may include attribute types and BLCK indicates a successful match, wherein a truck load has at least one dipper that corresponds to the target block. A matching engine within MMT may analyze the data to determine the data that does not match and/or the data that is missing. The data may not match because of an unsuccessful call for GPS data. The MMT tool may not receive sufficient GPS data because the GPS on the truck or shovel may not be working. For the 23% of the data that is missing, the system may backfill a certain amount of the missing data. The backfilling of the missing data may occur manually or automatically. The MMT attribute type of MANU indicates that the missing data is manually backfilled using shovel cut data or spatial data that replicates the operator process. The MMT attribute type of MISS indicates a missed record that was not completed manually, so the load cannot be mapped for the ore grade. The MMT attribute type of PRED indicates predictions around certain stockpiles.

The MMT attribute type of AUTO includes the automatic backfilling that uses averaging of the GPS data from the past 3 truck loads (prior to the truck load data that was missed). The system may use automated logic by filling the missing loads by looking back at 3 available loads and selecting the last known value for categories (ore, rock, grade, etc) and moving the average for the continuous variables. The continuous variables may include, for example, TCu (total copper) and AsCu (acid soluble copper). Such continuous variables are weighted by mass (e.g. % values of metal content). The system may only use automated backfilling with about 10% of the 23% of missing data. As part of the averaging for automated backfilling, the system may also include other rules such as, for example, not including the first truck load in a shift which is often not a full or accurate truck load. Additionally, the system may include other rules such as, for example, to not use averages beyond the 3 prior truck loads because the shovel may have moved too much since that time. Such rules are advantageously developed to improve accuracy. For example, by using too early of truck loads, the system may need to use averages of averages, which is far less accurate. The system may provide the MMT tool with the remaining 13% of the 23% of the missing data by using shovel cut data, which is the actual data.

The MMT tool may allow ore to be tracked from blast to dump at individual truckload locations. The MMT tool may collect and aggregate ore characteristics information at a truckload-by-truckload level. The tool may allow for downstream processes to leverage the block model geologic information, a highly targeted understanding of ore deliveries and locations, and reconciliation of dispatch information with physical processes. The tool may be used for productivity reporting, recovery modeling and other analyses. The MMT tool may also provide data management and data integration functionality to allow mine engineers to review and control the final data output. The MMT tool may provide the users with a much more granular and useful dataset than what may be possible with using only fleet management system data. The MMT tool may integrate with the block model data to provide real-time tracking (e.g., past 24 hours percent TCu deliveries) and improved process modeling and analysis (e.g., past 24 hours percent TClay deliveries).

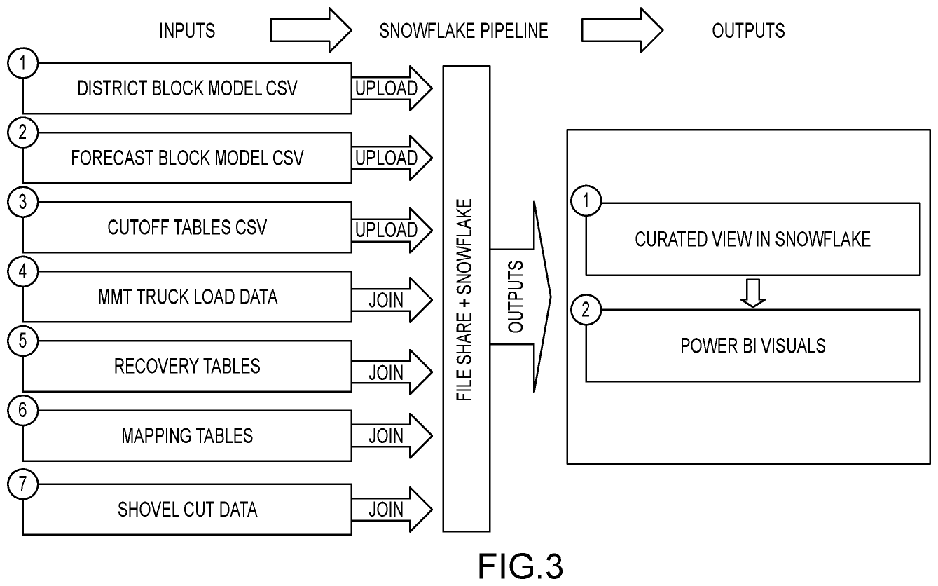

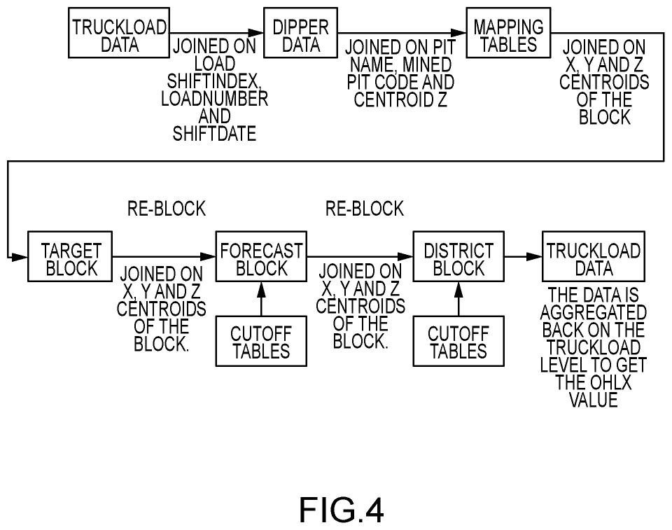

The MMT tool may provide GPS data from each swing of the shovel. As set forth in FIGS. 3 and 4, in various embodiments, the MMT tool may provide truckload data (which may be broken down into multiple dippers), dipper data and mapping tables. The truckload data may be joined into the dipper data by joining on load shift index, load number and shift date. The dipper data may be joined into the mapping tables by joining on pit name, mined pit code and centroid z. The dipper data is matched to the closest block centroid to determine where the shovel load was obtained from. The MMT tool may provide data for the short-range block model (target block). The system may also obtain such data from MMT and join the ingested data of truck load data and dipper data with the other input data. The data in the MMT tool may be stored as point data that includes the truck load data and dipper data. The MMT tool calculates the location of the dipper when the dipper shoveled the material to determine the dipper data. The dipper then dumps the material into the truck. The truck may contain three dipper loads, so the MMT tool may store an average of the three dipper loads as the truck load data. The system may take the point data from the MMT tool and change the block data into the point data, so the system is able to compare the data. The short-range model is using this data to obtain the rock type, ore type, copper grade, etc at that shovel point. The forecast model block may use data from the short-range block model and long-range block model. However, the long-range model and the forecast model may not be in the same format as the short-range model data, so the system may use mapping tables to provide consistency to at least a portion of the data. Furthermore, the models may include different block sizes, so the system may join the x,y,z centroids of the blocks. Moreover, cutoff tables may be used with the long-range model and the forecast model. If grade data is missing, then the system may use the shovel cut actual data to obtain the grade data.

The shovel cuts include the daily progress of the shovel. The system may aggregate a month of shovel cuts. The system may obtain the appropriate shovel cut files (e.g., to provide the missing 13% of data) based on the same area and the file names that include the effective start dates or time periods over which the material was mined. The shovel cut data may provide the actual amount of material that is scooped by the shovel over an area over a time period (e.g., a working day). The shovel cut data may be determined by mapping blocks with the shovel cuts. In various embodiments, the system may map blocks with shovel cuts to determine a percent grade in the shovel cut. A polygon may include an area of shovel cut data that represents the area that the shovel mined over a period of time (e.g., one day). The polygon may be placed over a block model of a mine. Some of the blocks may only be partially within the polygon, so the system may determine how to handle such blocks that may not be fully within the polygon. The system may simply provide rough estimates for how to use such partial block data because a small percentage of the overall tonnage (e.g., overall tonnage may be a million pounds per day) has missing data that needs to be backfilled with shovel cut data. Of that small percentage of missing data, a smaller amount of data needs to be determined using the few (if any) partial blocks in the polygon. In other words, the estimating of the partial blocks may not have a sufficient impact on the backfilled data.

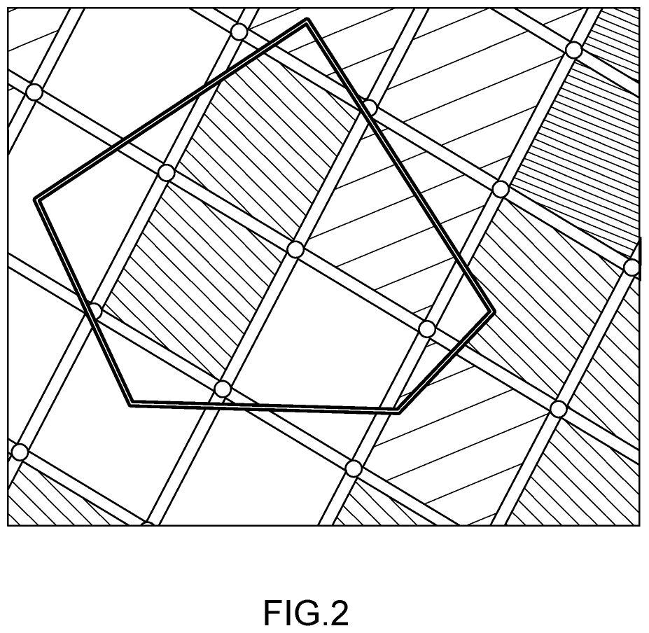

In various embodiments, the system may include any known or hereinafter developed polygon mapping techniques, algorithms or methods. The system may include a certain percentage of the block characteristics in the polygon data, depending on the parts of the block that are within the polygon. In particular, as set forth in FIG. 2, the system may consider five characteristics of the block, namely the corners (vertices) of the block and the centroid of the block. The system may determine the number of corners that are in the polygon and if the centroid is in the block, to help identify the overlap at a more granular level. For example, if one corner of the block is inside the polygon, then the system may include 25% of the block characteristics in the polygon data. If two corners of the block are inside the polygon, then the system may include 50% of the block characteristics in the polygon data. If three corners of the block are inside the polygon, then the system may include 75% of the block characteristics in the polygon data. If four corners of the block are inside the polygon, then the system may include 100% of the block characteristics in the polygon data. The system may also include (or refine) a certain percentage of the block characteristics in the polygon data, depending on if the centroid of the block is inside the polygon. For example, if one corner of the block is inside the polygon, but the centroid of the block is outside the polygon, then the system may include 25% of the block characteristics in the polygon data. If four corners of the block are inside the polygon, and the centroid of the block is inside the polygon, then the system may include 100% of the block characteristics in the polygon data. The system may use the weighted averages of the percentages of the block characteristics, the percent grade for each block in the polygon and the mass of each block in the polygon to determine the percent grade in the shovel cut (that was missed in the MMT tool). In various embodiments, the weighting may be implemented by using a mass weighted average such as, for example, (Mass1*Value1+Mass2*Value2)/(Mass1+Mass2). The system may also use the mapping tool and the polygon data to forecast percent grade over a period of time (e.g., 3 months) in certain areas.

As mentioned, in various embodiments, the system may determine how much material is mined based on the shovel cuts by using polygon shapes, solids and/or topography. Polygons recorded in a geographic information system (GIS) may define boundaries of the stockpiles and the sections. The polygon may be obtained at the mid-bench which includes a vertical from where the polygon is located to estimate how much of the material was removed from within 50 feet of the bench. The polygon includes assumptions about the shape of the polygon because of the sloping walls and assumptions about the distance from the bench, so the polygon may average around a mid-point. The solids use data about the amount of material that was physically removed, without the assumptions. The topography analyzes a current surface (e.g., this month) compared to a prior surface (e.g., last month).

The mine plan may, using user-defined table functions (UDTFs), forecast certain areas of certain polygons that are recommended to be mined first over a certain time period. However, in reality, the mining of certain areas may change during that time. For example, certain areas may be mined faster or slower, mine equipment may break down causing delays, inadequate dewatering, trucks are delayed (e.g., due to cracks in the road), slope issues that limit mining to the nighttime, etc. As such, as shown in FIG. 5, in various embodiments, the system may display which areas were actually mined overlayed on the mine plan showing the areas that should have been mined. The system may develop categories by quantifying the amount of area that was mined inside a planned area (mined as planned), not mined inside planned areas (planned not mined) and/or mined outside of the planned areas (mined not planned). The system may also identify trends of pit areas that are routed (or consistently routed) outside of the mine plan. The trends may be shown on a heatmap in the user interface, so the system can analyze the reasons for routing outside of the mine plan. The system may determine the tons and grades inside each of the categories. The system may use that data to determine the percentage of time the mining operations achieved the mining plan as forecasted (mined as planned), the percentage of material that was moved forward from subsequent months, the percentage of material that was deferred and how did each of the categories impact the amount (e.g., pounds) of metal that were obtained. If the system forecasted a certain grade, then the system may have forecasted a certain amount of metal within that grade. However, the short-range model may have determined a higher or lower grade, which impacts the amount of metal production. The system may also analyze the recovery data to determine if the mining operations were able to recover the amount of metal that was planned.

In various embodiments, the system may ingest the data from a workflow software application (e.g., Hexagon) that generates the inputs. The system may use an application programming interface (API) to call the application to provide the data and the system may store the data in a data warehouse. The system may then move the data into the stagging table for use by the system. By using the API call, the system may not need the file sharing, the csv files, the block models of shovel cuts, etc.

The input may be exported to .csv format and stored in a network data file with a particular structure and locations for the types of data. The system may find the appropriate data in the network data file, create a trigger file, then ingest the data into a data warehouse in the system. The data and objects may be stored in the stagging tables as raw data in the data warehouse. The system may not initially re-shape any of the data, so the raw data may be available in the future. The system may include base tables to conduct certain transformations. The system may also run a validation script to validate the data. For example, the validation script may confirm that the files and data follow various naming conventions, conforms to a desired order (or tabular form) of data and includes other critical items in the files. If the data does not meet certain validation requirements, the system may adjust at least a portion of the data or file to conform to the validation requirements. The system may provide a notification to the user about any of the data. For example, the system may notify the user about data that did not comply, missing data, job failures, corrupted data, lack of proper delimiters and/or data not meeting validation requirements, along with an explanation of the data failure. The user notification may be in response to the system not being able to fix the failure in the data or file. Using the information in the notification, the user may be able to fix the data and re-input the data.

In various embodiments, the system may include a workflow for data ingestion on file share. In general, the user may insert files in a folder. The files may include a proper file and naming convention. The user inserts a trigger file in the production directory which triggers a job chain. The system may notify the user about the status of the job. If the job runs successfully, the system ingests the data in base tables and collection tables. If the job fails with an error, the system may check for failure scenarios, suggest changes to the files to resolve the errors, then re-upload the updated file into the production directory. More specifically, in various embodiments, for a model, the system may suggest a naming convention and may suggest including the year in the file name. The year may be converted to January 1 of that year. The same model may be uploaded yearly, if the model has not changed since the previous year. The file may be uploaded to file share and the history may be maintained (e.g., on Linux box archive). A user may include an empty text file as a trigger file, whenever the user wants to have the data ingested. The system may delete the trigger file, in response to the job running successfully. The system may utilize simple queries to obtain data. For example, the system may include a query to list the cutoff files that were uploaded. The system may also include a query to list the shovel cut files that were uploaded. The system may also query to identify missing shovel cut files (not loaded into the system). For example, the system may presume that one file is due for all the dates in the date range and pit. If the system does not provide a missing files output, then no files are missing. The system may provide a query for the aggregation of the monthly reconciliation. For example, the system may provide a row of data for each pit name and route process, values of total dump tons, and total recoverable copper for truckload data, target district and forecast model.

The system may not go back to the dipper level, but instead, the system may use the truck load level data. As such, the data may be re-aggregated back to the truck load level to use in the different models (e.g., short-range, long-range and forecast models). For example, for a particular truck load using a short-range model, the system may determine the grade, pounds, the routing, etc. For the truck load using a long-range model, the system may determine the grade, pounds, the routing, etc. For the same truck load using a forecast model, the system may determine the grade, pounds, the routing, etc. The system may then compare the results of the three models to determine the differences.

The output from the system may include a collection table which is used in the user-defined table functions (UDTFs) reconciliation. The UDTF reconciliation is used in the Excel/PowerBI Visuals. The system may use the output data to compare to the predictions, then the system may modify the predictions to improve the predictions (e.g., by re-training the models) based on the actual data. The system may use big data and 3D statistics (e.g., kriging).

In response to a job failure, the system may send the user a notice about the job failure and the data files may be saved. A failure scenario may include, for example, the system receiving blank values for centroid coordinates for block model data. The system may resolve this failure scenario by eliminating any null values for centroids of block data. Another failure scenario may include files being in a format other than the csv format. The system may resolve this failure scenario by converting the file into a csv format and re-upload the file. Another failure scenario may include an incorrect number of columns in the data file. The system may resolve this failure scenario by re-uploading the file with the correct columns. A further failure scenario may include an incorrect order of columns in the data file. The system may resolve this failure scenario by re-uploading the file with the correct order of columns. Another failure scenario may include a storage issue in file share. The system may resolve this failure scenario by informing the end user and instructing the end user to clean the space in storage.

In various embodiments, the system may include a table function to format the data for use in a user interface. The user interface may allow the user to view data at the dipper level (e.g., each shovel load), and not just at a truck load level. The user interface can show the user, for different models and based on the cutoff tables, what the material is projected to yield, the optimal routes and where the material should be moved and processed. The system may use a UDTF that, in response to a simple query, provides a visual representation of numerous points representing such results overlayed over a block model having short-range blocks from blast holes. Each point may represent a single scoop of a shovel. The color of the points may represent different models and/or different models from different time periods.

To avoid (or minimize) the need to transform the query in SQL, the system uses user-defined requests inputted into the user interface like data range, site, etc. The user input may be part of UDTFs to obtain curated data that matches (or is similar to) the desired data. For example, the system may request data, based on the user request, for only copper, only molybdenum, only axles, only engine hours, etc. In this way, the resulting data set does not include extra unwanted data.

In various embodiments, the system may use a cutoff file. The cutoff file provides a process for determining the threshold grade for a type of ore for routing that type of ore to the most appropriate processing (e.g., most economical). For example, if the truck load of ore has greater than 0.3 total copper, then that ore may go to the mill. If the truck load of ore has less than 0.3 total copper, then that ore may go to the run of mine stockpile. However, if a higher-grade pocket of ore is being mined, then a disproportionate amount of the ore may go to the mill. The system may try to maintain the same amount (e.g., tonnage) of ore going to the mill versus the stockpile, so if a higher-grade pocket of material is being mined during a certain time period, the cutoff file may increase the threshold grade to determine the most appropriate routing between the mill versus the stockpile, based on a more equitable allocation of resources. Each ore type and rock type combination may have a different cutoff depending on the pit being mined. For example, if a pit is a longer distance from the mill, the cutoff may be lower, such that less material needs to travel a long distance to the mill.

The distance to the mill is often considered a variable cost partly because of the diesel fuel used by large mining haul trucks, shovels and other equipment. The price of this commodity causes swings in the costs of mining, and consequently, in the revenue that can be generated from each designated volume of ore. After the ore has been blasted to fragment the ore, the ore is loaded by large mining shovels into diesel fueled haul trucks. The distance between loading and the ultimate destination of a truck load of ore is the haulage distance. The costs of ore haulage are proportional to distance, but also depend on factors such as mine topography and the percentage of the haul that is uphill. Ore haulage costs are a significant mining cost and also depend on the cost of tires, tire life, and truck maintenance costs.

The system may determine a cutoff table for any selected date range. For example, the system may upload files containing long-range models and forecast models during a certain time period. The system may find the appropriate files (for a relevant time period) by reviewing the names of the files, because the file names may include an effective start date in the file name.

A distinguishing factor between a copper bearing mineral and an economic copper ore is the economic benefit that can be derived from extracting value from processing the material. The copper grade is a factor in this analysis. The copper grade is the amount of copper present in each ton of rock. The copper grade is often expressed as a percentage of total copper present. While knowing how much copper is present in the rock is a good indicator of economic viability, the amount of copper present in the rock does not necessarily tell the whole story. The copper mineralogy is also important, as well as the relative amounts of other valuable minerals that may be co-extracted with the copper. The amounts and values of economically important elements can be mathematically combined with the amount of copper to provide a copper equivalent grade. For example, when molybdenum sulfide is present in an orebody and can be co-extracted with the copper in the froth flotation process, the copper equivalent grade can be expressed as: Grade Copper Equivalent=% Cu+C*% Mo, where C is a factor based on the economic value of molybdenum in any current market conditions. Therefore, the copper equivalent grade of an ore that contains metal values in addition to copper can change according to commodity markets. This is important to ore routing because, while froth flotation is able to recover molybdenum in the form of the naturally occurring mineral molybdenum disulfide, leaching processes are typically not able to recover molybdenum. Likewise, the precious metals (e.g., gold, silver and platinum) may be recovered by froth flotation and smelting processes, but such precious metals may not be recovered by heap leaching. As such, the processes, mechanics and economics of ore routing may be optimized by utilization of models, simulators and engines that are adjustable according to metal pricing and market conditions. Ores that contain un-economic percentages of copper are said to be “below-cutoff-grade” materials. Because the processing cost via froth flotation and smelting is higher than that for heap leaching, ores that are below the “mill cutoff grade” may often be economically processed via leaching.

In various embodiments, a dispatch system may be used for tracking equipment status and/or position. The dispatch data may be used in the MMT. The dispatch system may also include cycle optimization (e.g., routing and scheduling based on mine plans as well as capacities of crusher, etc.), balance idle equipment times, balance queue times, manage fuel, operator's performance, productivity, etc. A typical haulage cycle may include receiving truck loads from the assigned shovel, traveling with a full truckload to an assigned dumping location, arriving at the dump queue, dumping the load, traveling empty back to the assigned shovel, arriving at the shovel queue, spotting, and then the cycle may repeat. The haulage cycle data may include a shovel identifier, a shovel location identifier, a truck identifier, a load time and data and a stockpile identifier. The spotting may be the appropriate locations for the truck to be able to receive the ore from the shovel or the appropriate locations for the truck to be able dump its load in the appropriate section.

The recovery file may include how much metal is expected to be obtained from the ore, depending on where the ore is routed. For example, ore type 3 has 82% recovery at the mill, 87% recovery using crushed leach and 50% recovery at the run of mine stockpile. The system may estimate recovery pounds using different types of models and the data flows discussed herein. Each model may predict different recovery pounds based on a determination of the process that may be used to recover the metal from the ore (e.g., crushed leach, mill, etc). Recoveries vary depending on the ore types and/or rock types, so different processes and different ore types may impact the recoveries of metal from the ore.

In various embodiments, the system may use mapping tables to help to standardize large data sets to allow for tracking of the data and easy comparisons between variances in geologic models and production models. The system may use an ETL (extract, transform, load) process (using any ETL tool or system) to update mapping tables using input files. The ETL tool may move data from one database, multiple databases or other sources to a data warehouse or other unified repository. The mapping tables help to standardize the data by mapping data from different sites (that may use a different naming convention) to similar data from other sites. For example, South America may use CUT for Copper Total and North American may use TCU for Total Copper. Also, even in the same region, Acid Soluble Copper may be indicated as ASCU, XCU, etc.

The standardization of the data also sets the foundation for robust operational and modeling analytics. The system may centralize model data in a data warehouse, such that the model data may serve as a platform for future analytics. The system may ingest data sets into a platform for storing, processing and analyzing data (e.g., Snowflake). The system may calculate certain fields from the ingested data such as contained copper pounds, recoverable copper pounds, etc. As such, the system may provide a single automated data set output to allow for quick and easy comparison of key performance indicators for any model and any date range. Therefore, the system may reduce the number of employees in the reconciliation process.

The software elements of the system may be implemented with any programming language or scripting language. While the system may be described in terms of copper production, the system may be similarly applicable to any type of minerals in any of the embodiments discussed herein. For example, the system may operate with any mineral for which value (e.g., metal value) may be recovered by leaching. While the system may be described with respect to haul trucks, shovels or other mining equipment, the system may operate and gather data from any type of vehicle or equipment in any of the embodiments discussed herein.

The system may provide output data that may allow adjustments to interacting sets of parameters to drive beneficial changes in mining (e.g., leaching, routing, processing) operations. The input data may relate to, for example, ore grade, recovery, processing cost, process efficiency, mine plan, block models and/or ore map. The system may also adjust models for increasing accuracy and/or consistency by checking the output data against reality. The system may also change (e.g., in real-time) ore routing calculations to adjust for changes in the output variables. Additionally, the system may optimize heap leach efficiency (which impacts the ore routing decision) by adjusting and optimizing the chemical and physical forces that drive copper extraction. The system may provide high prediction power (about 8-16% error).

The system may use ore placement targeting via dispatch, truck sensors (e.g., from one or more of the sensors), geographic information system (GIS) polygons and mineralogy from block model optimization to make better decisions about where to place ore and how to process the ore to improve production and/or recovery, while also considering real-world constraints. Machine learning models (e.g., predictive models) may be used to understand how ore characteristics and leaching practices impact both production and recovery at each stockpile. While the phrase predictive model may be used herein, the system contemplates the use of any machine learning model or supervised machine learning model. The system may build on these models to identify the best possible decisions to maximize stockpile production and/or recovery. To provide more practical recommendations, the system may implement constraints to reflect real-world limitations. The system may account for mineralogy information from the block model, dispatch and truck sensors, polygons, and the predictive models to create recommendations for where ore should be placed and how to leach it. Constraints may include, for example, available area, flow, acid, relative costs of transporting, relative costs of leaching and expected ore volume (produced by the mine and requiring placement). The system may consider thousands of data points (e.g., in seconds) to create practical recommendations (not replicable by humans) for maximizing production and recovery. The features of this system may be used with other leaching analytic systems such as, for example, the system in U.S. patent application Ser. No. 17/850,834 entitled “SYSTEM AND METHOD FOR ADJUSTING LEACHING OPERATIONS BASED ON LEACH ANALYTIC DATA” which was filed on Jun. 27, 2022 (now U.S. Pat. No. 11,521,138, issued on Dec. 6, 2022), which is incorporated by reference herein in its entirety for all purposes, except to the extent that the incorporated material is inconsistent with the express disclosure herein, in which case the language in this disclosure shall control.

In various embodiments, one model may cover multiple stockpiles. In various embodiments, a global model may summarize a leach at a phenomenological level that applies to any leach pile. In various embodiments, each stockpile or leach pad may be covered by a separate model. The term “stockpile” may be used herein, but the system may similarly apply to a stockpile, multiple stockpiles, a leach pad, multiple leach pads, a lift, multiple lifts, a section, multiple sections, etc. and the terms may be used interchangeably. The stockpile may include different layers called lifts (e.g., 50-foot height sections). A lift may be divided into sections, wherein the section may be any shape and size. Each section may be separately irrigated and tracked. The tracking for each section may include days under leach, raffinate flow, temperature monitoring, etc. The middle of a lift may include more uniform rectangular sections, while the edges of the stockpile may include irregular shaped sections because the edges may not be as uniform or consistently shaped as the middle of the lift. The system may also disclose herein the operation of a copper mine and the extraction of copper. However, similar systems, components, data and/or models may be used to obtain data about any type of mine or how to improve the extraction of any type of mineral.

In various embodiments, the system may incorporate data from different sources into the models and files. The system may include data from various sensors throughout the mine. The sensors may be located at different areas of the chemical plants or stockpiles. Flow sensors may be used to determine the flow rate in certain pipes, which may be used to determine application rates. Oxygen sensors may be used to measure the oxygen content in the stockpiles. Solution collection devices may catch the leaching solution partway through its leaching process for analysis. Solvent extraction and electrowinning (SXEW) sensors may be involved with the setting and simultaneous purification of the post-leaching solution. The purified solution may then undergo copper electrolysis, which results in cathode copper that meets quality and quantity criteria. In various embodiments, the system may also acquire data from sensors such as, for example, piezometers, gaseous oxygen sensors, other gas sensors, dissolved oxygen sensors, flow meters, conductivity meters, resistivity meters, x-ray analytical equipment, pH sensors, ORP sensors, thermistors, temperature sensors, load sensors, and/or bioactivity sensors.

Certain inputs may include data from a block model. Assays from drill holes may be fed into a tool for 3D interpolation of assays. The 3D assay may be incorporated into a block model. The block model data, the shovel high precision GPS data and modular dispatch data may be inputs into the MMT (mine mineral tracking) Tool. The system may receive inputs from one or more of the haul truck sensors for loading/dumping and dispatch data. The data from the MMT tool, the ArcGIS section polygons, elevation data, and the rules-based matching may be inputs into the system. The stockpile and section mapping, the irrigation data and the heat soft sensor may be part of the feature engineering tools that are fed into the models. A “report” may provide a summary of what happened at the mine over a certain period of time (e.g., 24 hours, a shift, etc.). The report may include information about ore placement, chemical applications, content information, etc. The system may obtain certain information and data from the report to feed into the models. The report information may be obtained from inputted data, sensors, servers, databases, historical data, dispatch data, other systems, etc. The report information may include information from servers because the different sensors may communicate with servers (e.g., PI servers from OSI) such that the servers store all (or a subset of) the sensor data.

The servers and components may provide information to an enterprise server or database. The system may include a data engineering (DE) pipeline that ingests the raw data, builds out features, aggregates data, builds the dataset for the models, creates output shapes and/or provides output. The DE pipeline may include SQL queries, feature engineering in any suitable code (e.g., Python code), etc. The DE pipeline may generate model input tables for a feature store. The feature store may include a data cloud or warehouse (e.g., Snowflake data cloud) where the data is written out from the DE pipeline or a database (e.g., Cosmos database) that stores different models and results (forecasts, backcasts, etc.). The feature store may provide data for model training, etc.

The system may use the forecasts and predictions to implement operational changes to optimize copper recovery, in advance of the ore being placed. As such, the system may provide advanced notice for implementing changes in ore processing methods and commodities purchases. For example, if the model shows that increased blast fragmentation may help the mining process and be economic, the system may provide a notification (or send a signal to implement a change in the drilling system and the purchasing system) to modify blasthole drill spacing and purchase additional blasting material. If the model shows that adding more acid may help the mining process and be more economic, the system may provide a notification (or send a signal to implement a change in the purchasing system) to purchase more acid at an advantageous price. If the model shows that copper extraction would be improved by higher temperature leaching, the system may provide a notification that the ore should be routed to a stockpile where heap covers or heat addition systems may be employed. Heat addition systems may include the use of solar, geothermal and/or heat from other processing operations by use of heat pumps, heat exchangers and/or direct heating technologies. Moreover, if the model shows that copper extraction would be improved by higher temperature leaching and/or aeration, the system may provide a notification or signal to air blowers (or an operator of the air blowers) to automatically increase airflow and increase the pile temperature. Further, ores that benefit from leaching at higher temperatures may (as shown by the heat soft model) benefit from co-placement with materials containing elevated levels of pyrite (generally above 2%). The system could provide notification to mine planners or input to mine planning models, so that pyritic materials are most beneficially co-placed with ores to increase leach temperatures through exothermic reaction mechanisms. In yet another example, sulfide ores which may benefit from air injection may be routed (based on a notification or instruction form the system) to stockpiles where air injection equipment (blowers and ducting) are located. In another example, for ores which may benefit from exposure to one or more leach additives or combinations of additives, the system could provide a notification (or send instructions to implement the change at an additive distribution machine), so that the optimum combination of additives is provided to the ore at the correct point in the leach cycle. Additionally, the model may show that a specific combination of parameters may provide optimized metal value recovery. In this case, the system may provide a notification (or send instructions) to make process changes such that each unit of ore mined is processed under optimized conditions. In various embodiments, the system may send a signal to other systems to change irrigation rates and/or aeration rates, in response to measured (e.g., real-time measurements), estimated and/or calculated inputs to the optimization simulations (e.g., optimization algorithms in a module). For example, if the system shows that a stockpile exhibits higher copper recovery when raffinate iron contents are high, the system may provide notification or send a signal to an iron addition system so that iron ions are added to the raffinate. The iron ions may be added to the raffinate by the addition of new iron to the system by a chemical addition system or by re-routing high iron solutions from other stockpiles. In another example, if the model shows that the biological content of a leach solution is beneficial for copper recovery, the system may provide a notification or send a signal to a bio-plant so that additional beneficial microbes are added to leach solutions. In another example, if the model determines that copper extraction is improved when raffinate copper concentrations are low, the system may provide a notification or send signals so that copper extraction in downstream solvent extraction plants is increased, thus providing a low grade raffinate. Other factors that may enhance mining economics include, for example, pH addition, % solids levels, reagent dosing, grind size and similar factors.

The forecast may be used to optimize future mine plans. Based on the forecast, the optimization process may be applied to inputs to suggest impactful changes. The system may suggest DUL (days under leach) cycles based on optimal forecasted production. The system may provide cross-pile forecasts that may drive optimization of placements between leach stockpiles. The system may determine an optimal diversion of raffinate between stockpiles to maximize leach production, so the system may send a signal to the raffinate dispenser or router to divert the raffinate over a different pathway. The system may determine dump allocations to lifts/piles based on forecasted production, so the system may send signals to the routing system (or directly to automated haul trucks) to change the routing of the haul trucks. The ore map tool may determine areas to automatically re-leach based on remaining Cu calculations, so the system may send a signal to a dispenser to automatically start a re-leaching process. The ore map may also determine areas to be re-mined based on a determination that re-mining efficiencies may exist, so the system may send a signal to a scheduling system or mining machine to start re-mining a certain area. In various embodiments, the system may determine that a particular stockpile on a particular area of a stockpile may benefit from increased acid addition. As such, the system may send a signal to an auto-valve that could be directed to open to a setpoint so that additional acid is added to the raffinate destined for a particular area under leach or to be leached. In various embodiments, the system may also determine (based on previous data or a column test model) that ore placed in a particular area of a stockpile may benefit from the addition of an additive or a combination of additives, microbes, and leach catalysts. As such, the system may send a signal to one or more auto-valves that could be directed to open to setpoints, so that one or a combination of additives, microbes, and leach catalysts may be added to the raffinate bound for a given area of the leach stockpile. Being able to model leach optimizations for future ore placements is also beneficial in that mine and haulage plans may be adjusted in advance. For example, if the system determines that ore from one or more locations in the mine would provide optimal copper recovery if it were stacked at a certain lift height (e.g., 20 feet), the mine plan can take this into account. An accumulation of data on optimal lift heights for all the ore to be leached year by year may allow calculations of stockpile dimensions to meet production requirements. These calculations may further help with enhanced land planning and water planning.

In various embodiments, the system may also include a forward-looking forecast model. The forecast model may use desired parameters as the input data to create future predictions. The forecast model may run scenarios and iterate quickly to determine how to maximize (and accurately estimate) future production. The forecast model may also be used to understand the drivers of performance and how to increase production in the future. The forecast model may forecast future production, based on how the stockpile behaved in the past and future production assumptions. The future production assumptions may include the settings and parameters that may be planned for the near future. In other words, the future production assumptions may include the setting of parameters for how the stockpile should operate in the future (e.g., over the next year). The forecast model may utilize the trained and tested predictive model, along with certain future production assumptions (which may be obtained from the mine plan). The forecast may use data from the mine plan (e.g., 1-5 year mine plan) such as, for example, geological exploration (e.g., data about where the sulfides (e.g., including pyrite), mixed ores and/or oxides are located in the mine map), route plan (e.g., route ore to a particular location over a period of time), irrigation plan, ore map, etc. The user may enter such mine plan data (obtained from other tools and sensors) into the system or the system may acquire such mine plan data from the tools and sensors. The forecast model may provide forecasting and predictions about the ore that has not yet been placed and will be leached under a set of predicted conditions. The forecasting process may combine estimates from a predictive model (trained on historical data on stockpile-level copper production) with forward-looking estimates of likely values for each predictor in the model. Estimates for predictors may be determined based on the mine plan (for placements and grades), recent historical values, DUL estimation or by ‘helper’ models that estimate settings via a predictive approach. End users may override these settings by inputting expert-determined values or different historical data via a graphical user interface.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices. The AI or ML may store data in a decision tree in a novel way.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112 (f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A method comprising:
finding shovel load locations between a period of time based on shovel load data from truck load data from a truck load of material;
associating the shovel load locations with a forecast model block and a district model block;
selecting a plurality of shovel loads that are associated with the forecast model block and the district model block, based on the shovel load locations;
matching the plurality of shovel loads with the truck load;
aggregating the plurality of shovel loads into the truck load, based on the truck load data, shovel load characteristics of the plurality of shovel loads being associated with forecast model block characteristics of the forecast model block and district model block characteristics of the district model block;
comparing forecast model block characteristics of the forecast model block and district model block characteristics of the district model block with target block characteristics of a target block; and
creating a reconciliation report of the target block characteristics of the target block based on the forecast model block characteristics and the district model block characteristics.

2. The method of claim 1, wherein the forecast model block represents a forecast block and the district model block represents a district block.

3. The method of claim 1, further comprising:
obtaining centroid data about the forecast model block and the district model block from the shovel load data for the truck load;
matching the centroid data to centroid data of the target block; and
determining the target block.

4. The method of claim 1, wherein the selecting the plurality of shovel loads that are associated with the forecast model block and the district model block comprises:
obtaining a value of a forecast model block for each of the plurality of shovel loads; and
obtaining a value of a district model block for each of the plurality of shovel loads.

5. The method of claim 1, further comprising at least one of:
assigning a route code to the truck load based on the truck load data;
re-calculating the route code based on grades in the forecast model; or
calculating cut-off files using the route code based on the truck load data.

6. The method of claim 1, further comprising determining copper recovery from the target block by the comparing of the forecast model block characteristics of the forecast model block and the district model block characteristics of the district model block with the target block characteristics of the target block.

7. The method of claim 1, wherein the reconciliation report includes the differences from the target block characteristics of the target block with the district model block characteristics.

8. The method of claim 1, further comprising determining at least one of the shovel load data that is missing or the shovel load data that does not match the truck load data.

9. The method of claim 1, further comprising backfilling the shovel load data that is missing by using at least one of shovel cut data, spatial data, prediction data, average data from past truck loads, or last known data from the past truck loads.

10. The method of claim 1, further comprising backfilling the shovel load data that is missing by using shovel cut data from shovel cut files from the period of time and over the shovel load locations.

11. The method of claim 1, further comprising:
overlaying a shovel cut progress polygon over a plurality of blocks within a block model of a mine, wherein the plurality of blocks include at least one of the forecast model block, the district model block or the target block;
determining a first subset of the plurality of blocks that are fully contained within the shovel cut progress polygon,
wherein the first subset of the plurality of blocks have first characteristics;
determining a second subset of the plurality of blocks that are partially contained within the shovel cut progress polygon, based on one or more vertices or centroids being within the shovel cut progress polygon,
wherein the second subset of the plurality of blocks have second characteristics; and
backfilling the shovel load data that is missing with shovel cut data having the first characteristics and a percentage of the second characteristics.

12. The method of claim 1, further comprising
determining the target block corresponding to the shovel load locations; and
determining the percentage of the target block that was mined.

13. The method of claim 1, further comprising at least one of:
determining a percent of a block within the block model that was mined, wherein the block includes at least one of the forecast model block, the district model block or the target block;
forecasting, using a mine plan with user-defined table functions (UDTFs), areas of polygons to be mined first over a period of time;
displaying mined areas overlayed on a mine plan, wherein the mine plan includes areas that should have been mined; or
creating area categories in a mine plan as at least one of mined as planned, planned not mined, mined not planned or routed outside of the mined plan.

14. The method of claim 1, further comprising determining, based on tons and grades inside each of the area categories, at least one of percentage of time mining operations achieved the mine plan as forecasted, percentage of the material that was moved forward from subsequent months, percentage of the material that was deferred or how each of the area categories impacted the amount of metal that was obtained.

15. The method of claim 1, further comprising determining, using recovery data, that a mine plan recovered an amount of metal that was planned.

16. The method of claim 1, further comprising joining the truck load data into the shovel load data using a load shift index, load number and shift date.

17. The method of claim 1, further comprising joining the shovel load data into mapping tables using pit name, mined pit code and centroid z.

18. The method of claim 1, further comprising providing, using mapping tables, consistent data for models.

19. The method of claim 1, further comprising displaying a point representing a shovel scoop of the material and at least one of projected yield of the material, routes for the material or processing locations for the material.

20. The method of claim 1, further comprising determining, using a cutoff file, a threshold grade for a type of the material for routing the material to at least one of a processing facility or a processing area.
